(19) United States
(12) Patent Application Publication
(10) Pub. No.: US 2019/0108488 A1
(43) Pub. Date: Apr. 11, 2019

(54) DRIVER EMPLOYEMENT APPLICATION SYSTEM AND METHOD

(71) Applicant: Richard K. Maidens, Fort Worth, TX (US)

(72) Inventor: Richard K. Maidens, Fort Worth, TX (US)

(21) Appl. No.: 16/157,584

(22) Filed: Oct. 11, 2018

Related U.S. Application Data
(60) Provisional application No. 62/570,910, filed on Oct. 11, 2017.

(51) Int. Cl. G06Q 10/10; G06F 7/02

(52) U.S. Cl. CPC G06Q 10/1053; G06F 7/026

(57) ABSTRACT

A driver employment application system includes a network having one or more of a server and a computing device; an application platform accessible from the computing device, the application platform having a registration portal to receive identifying information of an application; an application to receive answers to questions, the answers relating to driving employment qualifications of the applicant; the answers provide data to be analyzed; an algorithm to be implemented through the server, the algorithm is to receive the data from the application platform; and a ranking list generated by the algorithm, the ranking list including scores, each score associated with one applicant of the applicants; the ranking list provides an employer with a simple representation of qualifications associated with multiple applicants.

### BACKGROUND

### 1. Field of the Invention

The present invention relates generally to job application systems, and more specifically, to a driver employment application system for generating a list of potential employees suitable for convenient evaluation by an employer.

### 2. Description of Related Art

Job application systems are well known in the art and are effective means to receive information about potential employees. Commonly, employers provide applications for potential employees to fill out and answer questions. Once the employer receives these applications back, they have to weed through and evaluate each application to determine if the potential employee is a match.

One of the problems commonly associated with employment applications is inefficiency. For example, the employer has to look through many applications to determine if one or more of the employees would be a good fit. This can cause the employer to miss or lose out on more qualified applicants. In addition, potential employees typically have to fill out many applications to reach multiple employers.

The problem of inefficiency is particularly a problem for driving employers such as truck driving companies. Most application systems for truck drivers do not provide employers with a full and thorough evaluations of potential employees.

Accordingly, although great strides have been made in the area of application systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a driving employment application system in accordance with a preferred embodiment of the present application;

FIG. 2 is a simplified schematic of an application platform of FIG. 1; and

FIG. 3 is a flowchart of a method of the system of FIG. 1.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional employment systems. Specifically, the present invention provides a means to improve efficiency associated with hiring and applying for jobs, specifically for driving jobs. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

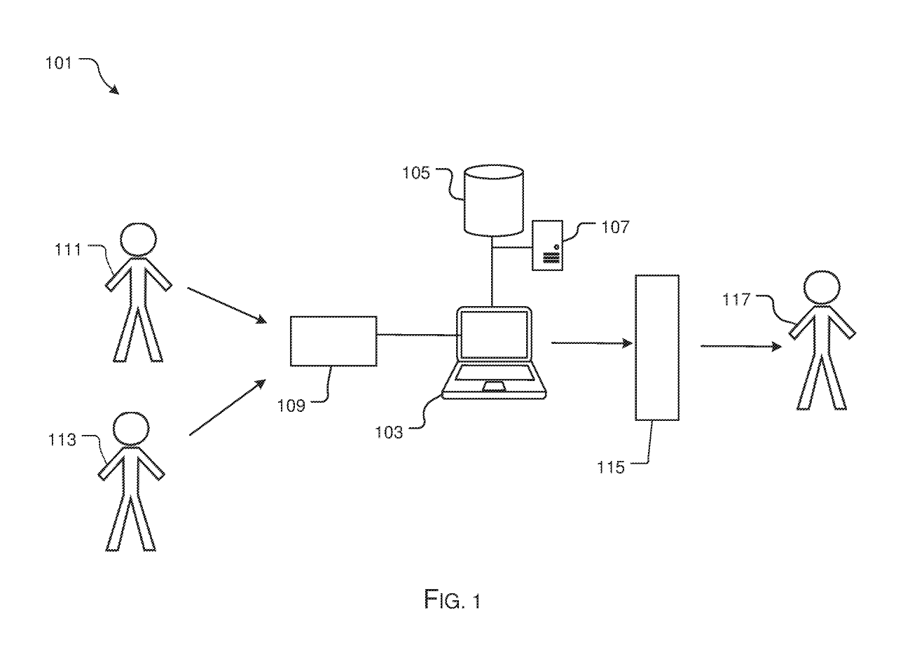

Referring now to the drawings wherein like reference characters identify corresponding or similar elements throughout the several views, FIG. 1 depicts a simplified schematic of a driving employment application system 101 in accordance with a preferred embodiment of the present application. It will be appreciated that system 101 overcomes one or more of the above-listed problems commonly associated with conventional employment application systems.

In the contemplated embodiment, system 101 includes a network having one or more of a computing device 103, a database 105, and a server 107. Computing device 103 and server 107 are configured to implement one or more algorithms to perform data analysis. System 101 includes an application platform 109 configured receive employment applications from one or more potential employees 111, 113. Upon receipt of the one or more applications, computing device 103 and/or server 107, perform data analysis via the one or more algorithms to create a ranking list 115, wherein the potential employees are ranked according to their information provided through the application. The ranking list 115 provides a potential employer 117 with a simple visual representation of the qualifications of a plurality of applicants. The employer can then select based on the scores displayed on the ranking list.

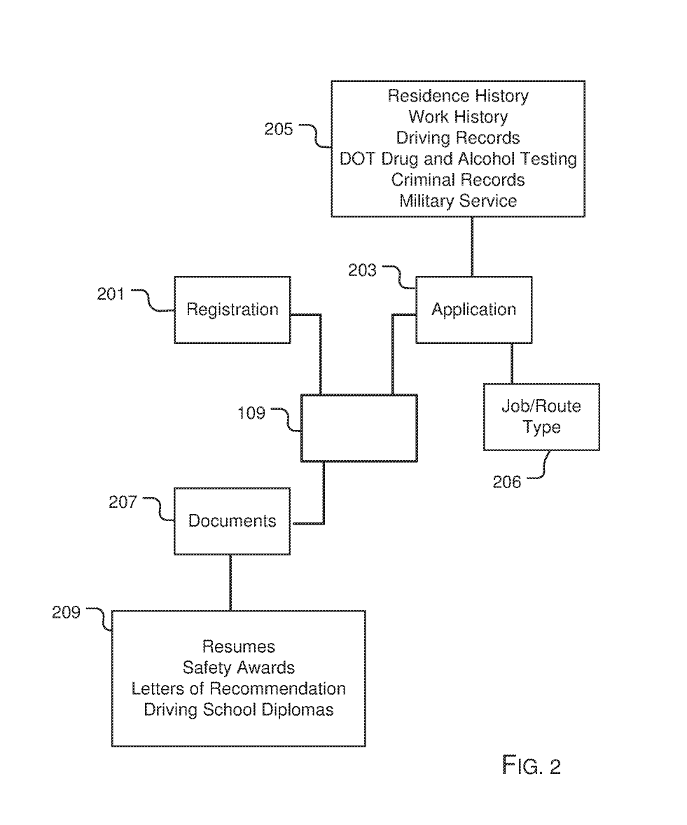

In FIG. 2 a simplified schematic depicts platform 109. It should be appreciated that platform 109 can be incorporated into one or more websites and/or applications, wherein the one or more algorithms is configured to operate. Portal 109 includes a registration portal 201, wherein an applicant provides identifying and personal information to create a profile. This information can include one or more of a name, an identifying number, an address, a photo, etc.

Platform 109 further includes an application portal 203, wherein an application 205 is generated to be provided to the one or more potential employees. The application 205 can include a plurality of questions, including one or more of questions relating to the potential employee's residential history, work history, driving records, drug and alcohol testing, criminal records, and military services. It should be appreciated that applications could be changed or modified. In addition, platform 109 can include a job and/or route type 206, wherein the one or more potential employees can provide information relating to jobs they are interested in. It should be appreciated that this feature is particularly important within trucking companies, as such information allows the one or more algorithms to select employees based at least partially on job/route type of interest.

In the preferred embodiment, the plurality of answers associated with the questions will generate numerical values. These numerical values can then be analyzed through an algorithm to create the applicant's personalized score. In some embodiments, the score is scaled, thereby assigning more or less weight to each question or information provided through the application.

Platform 109 can further include a document upload portal 207, wherein each potential employee can upload personal documents 209, such as resumes, safety awards, letters of recommendations, and driving school diplomas. Such documents can be used to increase each applicant's personalized score, thereby placing them higher in the ranking list. In addition, the documents provided can be evaluated separately by the employer.

In the present invention, the one or more algorithms receive location and job/route type preferences from the potential employees, this feature allows for employers to search for potential employees based on these features.

It should be appreciated that one of the unique features believed characteristic of the present application is the use of a single application provided to a plurality of potential employees to create a ranking list, wherein the ranking list is specifically directed to driver employment. It should be appreciated that the application is tailored to information necessary to determine a potential employee's qualifications within the driving industry. In addition, it should be understood that the combination of creating a ranking list, as well as collecting information to allow employer to narrow a search to a specific job/route type and/or location of employees, creates an efficient means for employers to evaluate the qualifications of potential employees.

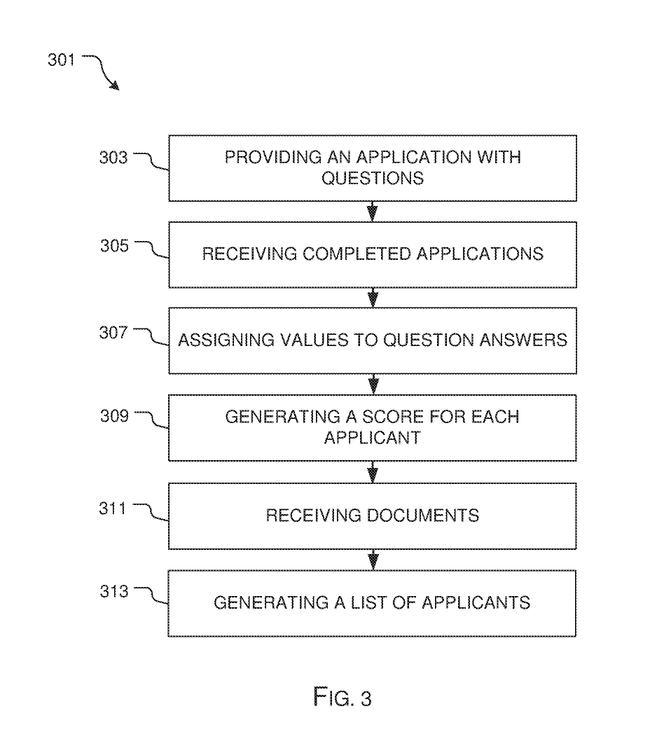

In FIG. 3, a flowchart 301 depicts a method associated with the present invention. An application with a plurality of questions, wherein the questions are specifically directed to qualifications sought for drivers, is provided to a plurality of potential employees, as shown with box 303. Once a plurality of applications are received into system 101, potential employees are given a score based on values assigned to their answers, as shown with boxes 305, 307, 309. It should be appreciated that the score can be scaled based on differing weight for different questions. Applicants can be given the opportunity to provide documents, as shown with box 311. A list of potential applicants is then created, wherein the list provides a visual representation to potential employers regarding the qualifications of applicants, as shown with box 313.

It is contemplated that platform 109 can also include a payment portal, wherein potential employers can pay to receive the ranking list, thereby providing a means of revenue for system 101.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A driver employment application system, comprising:
a network having one or more of a server and a computing device;
an application platform accessible from the computing device, the application platform having:
a registration portal configured to receive identifying information of an application;
an application configured to receive a plurality of answers to a plurality of questions, the plurality of answers relating to driving employment qualifications of the applicant;
wherein the plurality of answers provide data to be analyzed;
an algorithm configured to be implemented through the server, the algorithm is configured to receive the data from the application platform; and
a ranking list generated by the algorithm, the ranking list including a plurality of scores, each score associated with one applicant of a plurality of applicants;
wherein the ranking list provides an employer with a simple representation of qualifications associated with multiple applicants.

2. The system of claim 1, wherein the plurality of questions are directed toward one or more from:
a. residence history;
b. work history;
c. driving records;
d. DOT drug and alcohol testing;
e. criminal records; and
f. military service.

3. The system of claim 1, wherein the algorithm is configured to apply a numerical value to each of the plurality of answers.

4. The system of claim 1, wherein the application platform further comprises:
a document input portal configured to receive one or more documents from the applicant.

5. A method of generating a list of potential employees, the method comprising:
providing an application with a plurality of questions to a plurality of potential employees;
receiving completed applications having a plurality of answers to the plurality of questions from one or more of the plurality of potential employees;
assigning a value to each of the plurality of answers;
assigning a score to each of the plurality of potential employees based on the assigning of values; and
generating a list of potential employees, wherein the potential employees are arranged based on a plurality of scores;
wherein the plurality of questions are directed toward employment qualifications for driving jobs.

6. The method of claim 5, wherein the plurality of questions are directed toward one or more from:
a. residence history;
b. work history;
c. driving records;
d. DOT drug and alcohol testing;
e. criminal records; and
f. military service.

7. The method of claim 5, wherein the assigning of a value and the assigning of a score is accomplished via an algorithm executed on a computing device.

8. The method of claim 5, further comprising:
receiving a plurality of documents from each of the plurality of potential employees.

9. The method of claim 5, wherein the method is achieved through a website.
